(19) United States
(12) Patent Application Publication
(10) Pub. No.: US 2010/0063906 A1
(43) Pub. Date: Mar. 11, 2010

(54) SYSTEMS AND METHODS FOR AUTHENTICATION OF A VIRTUAL STORED VALUE CARD

(75) Inventors: David A. Nelsen, Tigard, OR (US); Leslie Arifin, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: GIFTANGO CORPORATION, Tigard, OR (US)

(21) Appl. No.: 12/554,792

(22) Filed: Sep. 4, 2009

Related U.S. Application Data
(60) Provisional application No. 61/094,654, filed on Sep. 5, 2008.

(51) Int. Cl. G06Q 40/00; G06Q 10/00

(52) U.S. Cl. 705/30; 705/44

(57) ABSTRACT

A virtual card management system including one or more servers having memory executable via a processor is provided. The virtual card management system including a virtual card manager executable on the one or more servers having an integration connector engine configured to communicatively link at least one card service provider and the virtual card manager. The virtual card management system may further include a virtual card management platform configured to communicatively link the virtual card manager with at least one virtual card engine, each virtual card engine including one or more virtual cards, the virtual card management platform including an enablement module configured to selectively enable a virtual card transaction between at least one virtual card and a corresponding card service provider based on a set of predetermined authentication rules.

### CROSS-REFERENCE TO RELATED APPLICATIONS

This application claims priority to U.S. Provisional Patent Application No. 61/094,654, filed Sep. 5, 2008 entitled “SYSTEMS AND METHODS FOR PERIODIC AUTHENTICATION OF A VIRTUAL CARD” the entire contents of which are hereby incorporated herein by reference for all purposes.

### FIELD

The present disclosure relates generally to systems and methods for secure fulfillment and authentication of virtual cards, and more particularly to systems and methods for fulfillment and authentication of virtual stored value cards presented from a mobile computing device.

### BACKGROUND AND SUMMARY

Plastic gift cards have become a popular form of payment in today's marketplace. Consumers typically purchase a select goods and services system's gift card and then present the plastic gift card to the brick and mortar location for redemption. Many times the purchaser of the gift card carries the gift card in their wallet for a period of time prior to redemption. During redemption, the user may sort through his wallet and hope that the card has not been lost or otherwise misplaced.

As the use of gift cards has become more and more popular, consumers are likely to carry a number of such gift cards in their wallet. Typically, the gift cards are only redeemable at a single goods and services system's or merchant's establishment or a limited number of merchant establishments. As such, the number of gift cards that are carried and maintained by an individual consumer is significant. A consumer may have similar problems with plastic and paper loyalty cards, such as membership cards, rewards card, points card, advantage cards, and/or club cards. Thus, the use of such cards may further increase a consumer's physical wallet size.

The inventors herein have recognized the difficulties of managing the large number of cards which are maintained by a consumer. Due to the number of these cards that a consumer may manage, consumers may physically stretch their wallets to carry the large number of cards. The consumer may desire to reduce the number of cards that are carried in the physical wallet or purse.

The issuance of a plastic card also increases the potential for loss or misplacement of the card. Furthermore, fraudulent use of cards may occur if the card is lost and then redeemed by a third party. The failures of the cards may negatively affect the card holder, goods and services system, and/or the card service provider as well as the industry as a whole.

As the inventors herein have recognized the difficulties with the plastic issued cards, alternative methods and systems for electronic cards have been developed. These electronically-issued and managed cards are referred to herein as virtual cards. The virtual cards may include, but are not limited to, one or more of a virtual gift card, a virtual loyalty card, a virtual membership card, and a virtual rewards card.

As further disclosed herein, systems and methods are provided to build a new level of security into the virtual card arena. As such, in one approach, a virtual card management system including one or more servers having memory executable via a processor is provided. The virtual card management system may include a virtual card manager executable on the one or more servers having an integration connector engine configured to communicatively link at least one card service provider and the virtual card manager. The virtual card management system may further include a virtual card management platform configured to communicatively link the virtual card manager with at least one virtual card engine, each virtual card engine including one or more virtual cards, the virtual card management platform including an enablement module configured to selectively enable a virtual card transaction between at least one virtual card and a corresponding card service provider based on a set of predetermined authentication rules.

In this way, the state of a virtual card may be toggled between an enabled state and disabled state to increase the security of a virtual card management system. When the card is in an enabled state, it may be available for use. Authentication rules may be used to trigger toggling the state of the virtual card. Authentication rules may be established and/or adjusted based on a select merchant's needs or desires regarding security.

With this system, the goods and services system can build rules around their card program to protect their card holders and prevent loss or fraud. Communication between the card service provider, goods and services system, and the virtual card engine can be taken to another level, allowing for increased levels of promotional capabilities and interaction with card holders. This new level of security and authentication can provide a safe transaction experience for all parties involved.

### BRIEF DESCRIPTION OF THE FIGURES

FIG. 1 shows a high level schematic depiction of a virtual management card system according to an embodiment of the present disclosure.

FIGS. 2A and 2B show a detailed schematic depiction of the virtual card management system, illustrated in FIG. 1, according to an embodiment of the present disclosure.

FIG. 3 shows an exemplary method which may be used to enable and disable the use of a virtual card.

FIG. 4 shows an example process flow of a method for setting up and using a virtual card which may be implemented via a virtual card management system according to an embodiment of the present disclosure.

FIG. 5 shows an example process flow of a method for setting up a virtual card.

FIG. 6 shows an example process flow of a method for setting up a virtual card engine on a mobile computing device for management of a virtual card.

FIGS. 7-9 show various illustrations of an example mobile computing device presenting a virtual card on a display.

### DETAILED DESCRIPTION

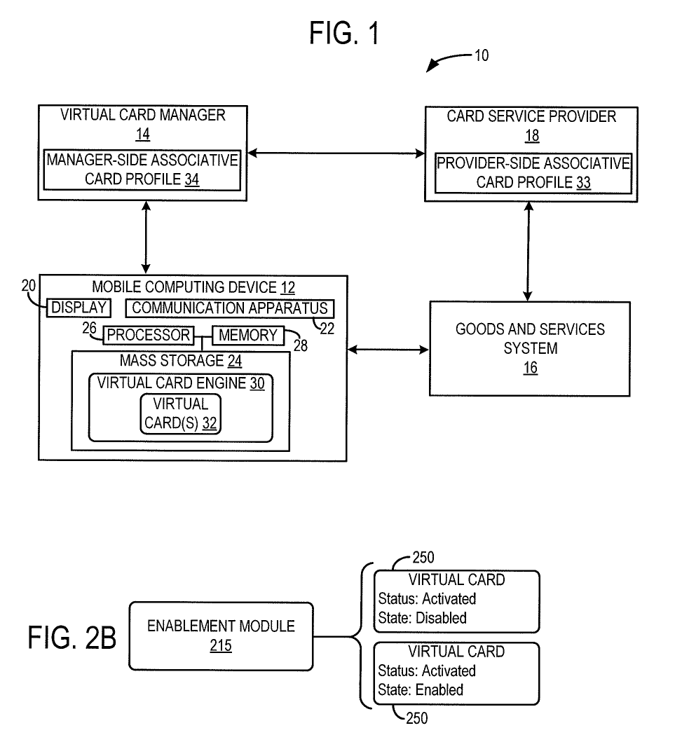

FIG. 1 shows an exemplary schematic illustration of a virtual card management system 10 according to an embodiment of the present disclosure. Among other things, the virtual card management system may be configured to selectively enable the use of at least one virtual card based on a set of predetermined authentication rules. As such, the system provides a secure method to enable fulfillment of virtual cards from mobile and stationary computing devices. Delivery of virtual cards to a computing device enables use of the virtual card and subsequent enablement/disablement of the virtual cards with an associated third party card provider. Presentation of the virtual card enables identification of who is attempting to use the virtual card. Based on the identification information and pre-established authentication rules, a virtual card may be temporarily enabled for use and may be retained in a temporarily disabled state when it is not being presented for use with a merchant. In this way, the security of the virtual card may be enhanced when compared to a plastic card system, preventing the card from being used by an unauthorized third party. Various security features, such as selective enablement, authentication, etc., are discussed in greater detail herein.

Virtual card as used herein may be an electronically-issued and/or electronically maintained virtual value card. A virtual value may be any type of privilege, monetary or non-monetary. For example, a virtual value card may be a stored value card which may include, but is not limited to, a virtual gift card, a virtual loyalty card, a virtual rewards card, a prepaid card, or another suitable virtual card that holds prepaid value. The stored value card may have monetary or other forms of value stored on the virtual card. In another example, a virtual value card may be a virtual membership card where such stored value includes membership privileges or identification-related privileges. An example of virtual membership cards may include, but are not limited to, virtual identification cards, club cards, promotional cards, identification cards (ID cards), etc.

As depicted in FIG. 1, virtual card management system 10 may include a mobile computing device 12, a virtual card manager 14, at least one goods and services system 16, and at least one card service provider 18. The mobile computing device may be a suitable computing device that enables a user to store and maintain one or more virtual cards. For example, the mobile computing device may be a smart phone, a hand-held computing device, an advanced PC-like capable mobile device, a laptop computer, a portable media player, etc. In some embodiments, the mobile computing device may run an identifiable operating system's software and provide a standardized interface and platform for applications. The mobile computing device may be networked to one or more networks, such as a public network (e.g. the Internet), to enable communication for authentication of the virtual card.

Mobile computing device 12 may include a display 20 configured to present graphics on the device. The mobile computing device may also include a communication apparatus 22 facilitating wired and/or wireless communication between the mobile computing device and external systems and devices (e.g. the virtual card manager, the goods and services system, and the card service provider). As depicted the mobile computing device may include various software applications stored on mass storage 24 and executable via a processor 26 using portions of memory 28. In some embodiments, mass storage 24 may be a hard drive, solid state memory, a rewritable disc, etc. The mass storage 24 may include various programmatic elements such as a virtual card engine 30 configured to manage one or more virtual card(s) 32. The virtual card engine 30 may be a software application configured to implement various virtual card functions, discussed in greater detail herein.

The virtual cards 32 may be stored value cards, such as gift cards, membership cards, virtual identification cards, etc. Each virtual card may include one or more related card data, including, but not limited to, an identification (ID) number, a stored value, a name, a bar code, image data (e.g. picture of a card holder), data corresponding to the associated goods and services system through which the card may be used, etc. The virtual cards 32 may be stored or maintained by a user in a mobile card wallet. The mobile card wallet may be a virtual electronic wallet (file or application) that manages virtual cards. In some systems, the mobile card wallet may enable a user to organize and access the virtual cards similar to how a tangible physical wallet enables storage of plastic cards. The mobile card wallet may be client-based software on the mobile computing device or may be browser-based software accessed by a mobile computing device.

As used herein, the goods and services system 16 (also referred to generally as the merchant) may be a system configured to manage goods and services transactions. As such, the merchant may be the store selling or providing goods and/or services that desires to have their card data or stored value issued electronically or virtually through a mobile or other electronic device. In other examples, the merchants may include card service providers which may be a third party service or provider that represents a gift card or other card services on behalf of a select merchant. The card service provider may be a third party stored value company, a module or software component of the merchant's existing Point of Sale (POS) software and/or provider, and/or application or software purchased, created, or used by the merchant to track the gift card services on behalf of the merchant.

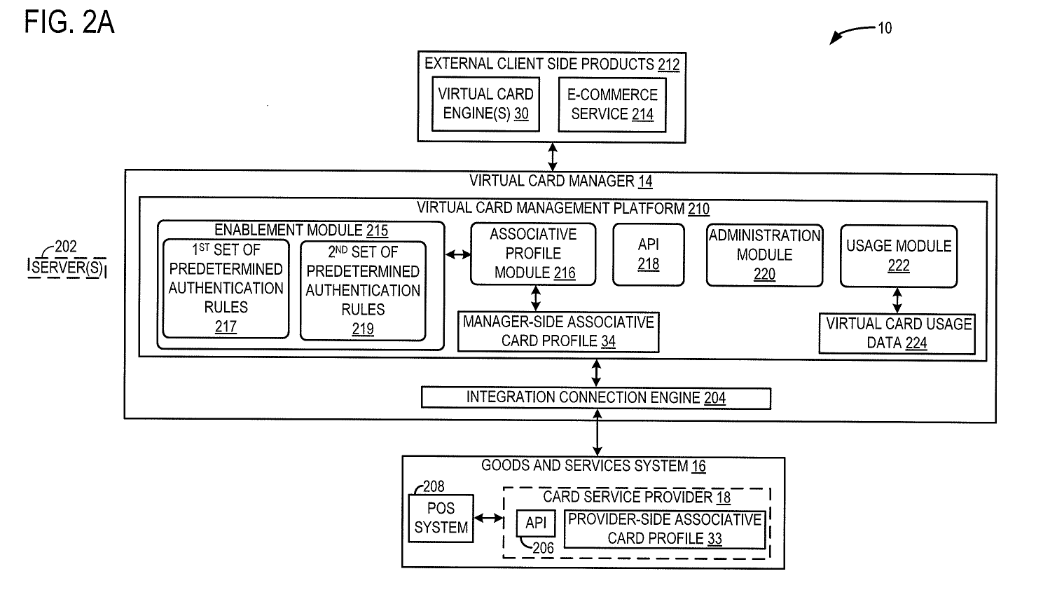

In some examples, the goods and services system 16 may be configured to virtually or electronically issue card data such as loyalty data, membership data, value data (e.g. monetary data), etc., through a mobile computing device or other electronic device. The goods and services system may include a POS system, discussed in greater detail herein with regard to FIG. 2, which may include software and hardware to manage electronic transactions. It will be appreciated that the goods and services system 16 may be associated with one or more merchants. The merchants may include one or more coffee shops, fast food restaurants, hotels, supermarkets, etc. Therefore, the goods and services system 16 may process a transaction at a brick and mortar location, in some examples. However, in other examples the goods and services system 16 may process transactions over the Internet. One type of exemplary transaction may include an electronic transaction, such as a virtual card transaction, discussed in greater detail herein.

In some embodiments, goods and services system 16 may directly manage and control virtual card transactions. In other words, card service provider 18 may be included in the goods and services system 16. However, in other embodiments, the goods and services system 16 may use an external card service provider. Thus, a third party card service provider may be used in some embodiments. The card service provider 18 may enable the goods and services system 16 to perform virtual card transactions. As an example, the third party card service provider may be the software and hardware configured to perform virtual card transactions on behalf of a selected goods and services system. As discussed above, the third party card service provider may include both hardware and software which, among other things, may be configured to electronically process virtual card transactions.

It will be appreciated that virtual card transactions may include stored value management transactions, such as monetary transaction in which the stored value of a virtual card is adjusted (e.g. decreased or in some situations increased). Additionally, the virtual card transactions may also include management of electronic privileges (e.g. card holder privileges) such as electronic access to certain types of data. Therefore, a transaction may include communication between two systems, devices, etc., in which value and/or privilege data is exchanged and/or manipulated. For example, a virtual card transaction may include deducting value from a virtual card in exchange for a good or service at a merchant location associated with a goods and services system. Further, in other examples a virtual card transaction may include, scanning or otherwise communicating (e.g. NFC—Near Field Communication) a virtual membership card at a merchant location associated with a goods and services system and granting access privileges to the merchant location. Further, it will be appreciated that, in some examples, a transaction may include implementation of security protocols.

As briefly mentioned above, card service provider 18 may be a third party stored value system or a module or software component of the goods and services system's existing POS system created or used by the goods and services system to track the virtual card services on behalf of the goods and services system. A goods and services system's POS Provider may be software, hardware, and/or other devices configured to process goods and services transactions at a location. Often times the POS may have a module or built in capability, thus making the POS System also a “Card Service Provider”.

Card service provider 18 may be configured to generate at least one provider-side associative card profile 33, each associative card profile corresponding to a virtual card. The provider-side associative card profile 33 may include virtual card data such as stored value (e.g. monetary value, point value), identification (ID) data (e.g. ID number, personal identification numbers), a card holder name, etc. A selected provider-side associative card profile may be accessed and adjusted during a virtual card transaction. It will be appreciated that the provider-side associative card profile may be included in the goods and services system, in some embodiments.

The card service provider 18 may be communicatively linked with a virtual card manager 14. The virtual card manager 14 also may be communicatively linked with the mobile computing device 12. In some systems, it will be appreciated that the virtual card manager 14 may also be communicatively linked with goods and services system 16.

Virtual card manager 14 may be configured to manage a plurality of virtual cards. In particular, the virtual card manager 14 may be configured to manage various security features of the virtual cards such as selective enablement (e.g. access control via authentication). For example, use of a virtual card may be selectively enabled (e.g. enabled or disabled). It will be appreciated that the virtual card may have an “activated” status while the virtual card is selectively enabled. Thus, the virtual card may be “activated” but in an enabled or disabled state. In this way, use of the virtual card may be quickly turned “on” and “off” without deactivating the virtual card, thereby enhancing the security of the virtual card when compared to plastic gift cards which remain in an enabled state subsequent to activation. Authentication and selective enablement of the virtual cards are discussed in greater detail herein with regard to FIGS. 2-6.

The virtual card manager 14 may include at least one manager-side associative card profile 34. The manager-side associative card profile 34 may include virtual card data such as stored value (e.g. monetary value, point value), identification (ID) data (e.g. ID number, personal identification numbers), a card holder name, etc. A selected manager-side associative card profile may be accessed and adjusted during a virtual card transaction. As described in more detail below, the system may match the provider-side associative card profile 33 with a virtual card's manager-side associative card profile 34.

As described in more detail below, in one example, a virtual card system may be set up such that a virtual card manager is able to enable and disable a virtual card. A merchant may then be communicatively linked to the virtual card manager. The merchant may be able to select a level of security and/or fraud protection. Depending on the security level, a rule set may be applied for virtual cards associated with the merchant. The rule set will then be applied with use of virtual cards associated with the merchant

For example, a virtual card may be delivered to a user through a computing device, such as a stationary computing device or a mobile computing device. In one example, the virtual card may be delivered for use to a user's mobile computing device. Predetermined authentication rules, also referred to as security rules, may be associated with the virtual card. The authentication rules may be implemented such that the state of the virtual card (e.g. enabled state, disabled state, etc.) may be managed by the virtual card manager. In some systems, the virtual card manager may be a remote server while in other systems, the virtual card manager may be on the mobile computing device.

As an example, depending on the authentication rules, use of the virtual card may be limited to an identified mobile computing device such that an attempt to use the virtual card from an unidentified (unassociated) mobile computing device is blocked. When such a use is requested, the virtual card may remain in a disabled state, thereby preventing the unauthorized use of the card. Again, depending on the rule set, in some systems, a merchant may be able to over-ride the disabled state if additional identification is provided. Although the above example is described in regards to identification of a single mobile computing device, in some examples, a user may be able to introduce additional computing devices as authorized computing devices. In such systems, the rule set may enable identification of a requesting computing device as an authorized computing device such that the state of the card is enabled.

Although only a single card service provider and mobile computing device are depicted in FIG. 1, it will be appreciated that virtual card manager 14 may act as a common platform for managing a large number of virtual cards corresponding to a plurality of card service providers. In some examples, two or more of the card service providers may have different characteristics. For example, two or more of the card service providers may utilize different communication protocols and may be linked to different goods and services systems and therefore provide different services. Furthermore, a card service provider may provide different types of card services. For example, one card service provider may provide membership card services while another card service provider may provide gift card services. In this way, a single virtual card management system can be used to manage a large number of virtual cards, facilitating scalability of the virtual card management system, thereby enhancing the market appeal of the virtual card management system.

Turning to FIG. 2A, a detailed schematic depiction of virtual card management system 10 is illustrated. The virtual card management system 10 may be configured to deliver and manage virtual cards as well as generate a common platform for use with a plurality of card service providers. Regardless of the card service provider's program or data requirements, the common platform enables the various card service providers and goods and services systems to exchange data and transfer products, such as virtual card products and services between the different card service providers.

As illustrated, virtual card management system 10 may include virtual card manager 14 which may be stored and executed on one or more servers 202, as discussed above. In particular, the virtual card manager 14 may be stored and executed on one or more remote servers. However, in other embodiments the virtual card manager 14 may be stored and executed on servers included in the goods and services system 16 and/or the card service provider 18. As such, the disclosed virtual card manager may be provided under an Application Service Provider (ASP) model as well as a software installation model. For example, an API approach may be provided where a merchant sells a virtual card through their own e-commerce set-up such as a website. The merchant may then utilize the above systems and methods to issue and provide tracking and authentication of the virtual card. In other embodiments, a merchant may directly install the above systems or applications for merchant-specific processing of the virtual cards on their own servers.

As discussed in more detail below, it should be appreciated that in some systems, so long as the API or other software provided by the POS or card service provider is linked to the virtual card manager to enable communication with the POS or card service provider, the virtual card manager can generally set up periodic virtual card authentication without those parties having to make any coding changes. In some embodiments, should a card service provider wish to make coding changes on their end, additional options or services may be enabled.

The virtual card manager 14 may include an integration connection engine 204 configured to communicatively link the virtual card manager 14 with at least one card service provider 18 via an API 206 or other software communication standard included in the card service provider. In this way, the virtual card manager 14 may communicate with the card service provider 18. When a plurality of card service providers are communicatively linked to the virtual card manager 14, at least a portion of the card service providers may utilize different communication protocols, communication hardware, security protocols, etc. Thus, the integration connection engine 204 allows the virtual card manager 14 to interact with a number of different card service providers. In other embodiments, the card service provider 18 may wish to use an API or other software provided by the virtual card manager to enable communication. In further examples, the card service provider 18 may include other methods or systems for communicating with the virtual card manager 14.

Additionally, it will be appreciated that the integration connection engine 204 may include at least one virtual card adapter configured to modify the data sent and received to and from the goods and services system into a common programming language, such as XML. However, in other embodiments the integration connection engine 204 may not include a virtual card adapter.

Thus, it will be appreciated that once the virtual card manager 14 and the card service provider 18 have been communicatively linked via the integration connection engine 204, the goods and services system 16 linked to the card service provider 18 may be able to increase its virtual card capabilities. As an example, the virtual card manager 14 and the card service provider 18 may work together to offer capabilities that include, but are not limited to, activating cards, deactivating cards, reactivating cards, voiding cards, voiding prior transactions, query of card balance, update to card value, query of card usage history, periodic authentication capabilities, communication of loyalty data, card fulfillment to email, mobile or other devices, etc. System capabilities will depend on the level of integration between the virtual card manager systems and that of the card service provider. The aforementioned capabilities are exemplary in nature and additional or alternate capabilities may be provided, in other embodiments.

Card service provider 18 may be included in the goods and services system 16, as discussed above. However, it will be appreciated that in other embodiments the card service provider may not be included in the goods and services system. The goods and services system may include point of sales (POS) systems 208 configured to electronically process goods and services. However, it will be appreciated that alternate system may be utilized to electronically process goods and services.

Additionally, the virtual card manager 14 may include a virtual card management platform 210 which may, among other things, be configured to provide virtual card services to a plurality of mobile computing devices via external client products 212, including virtual card engine(s) 30 and/or an e-commerce service 214. It will be appreciated that a virtual card engine may be stored on a mobile computing device. However, in other embodiments a virtual card engine may be stored on a server connected to the Internet. Thus, a virtual card engine may be accessed via a browser. As discussed above, the system shown in FIG. 2 may be utilized as an e-commerce sales solution. In some embodiments, an API approach may be provided where a goods and services system sells a virtual card through their own e-commerce system and then utilizes the above systems to issue and provide tracking and authentication of the virtual card. In other embodiments, a goods and services system may directly install the above systems or applications for merchant-specific processing of the virtual cards on their own servers.

The virtual card management platform may include an enablement module 215 configured to selectively and periodically enable a virtual card transaction between at least one virtual card and a corresponding card service provider based on a first set of predetermined authentication rules 217. Therefore, the enablement module may select an enabled or disabled state of a virtual card. It will be appreciated the virtual card may be “active” while the state of the virtual card is adjusted (e.g. selection of an enabled or disabled state). An enabled state may include a state in which a virtual card transaction between a virtual card and a corresponding card service provider is permitted and a disabled state may include a state in which a virtual card transaction between a virtual card and a corresponding card service provider is inhibited. A corresponding card service provider may manage the stored data pertaining to the virtual card in use. The stored data may be included in the provider-side associative card profile 33.

In some examples, periodically authenticating by selectively enabling a virtual card transaction may include toggling the card from a disabled state to an enabled state. This toggling between the enabled state and disabled state may be considered periodic authentication. The toggling of the card may be initiated at select events or times, such as immediately prior to the virtual card use. The toggling enables enhanced control of the security of use of the virtual card, as a card may only be used in an enabled state. The value data stored on the virtual card engine and/or provider-side associative card is retained during this process. As previously discussed, value data may include monetary data and/or membership service data. It will be appreciated that different methods may be used to toggle the state of the virtual card. For example, in some systems, the toggling may enable the stored value on and off depending on the capabilities offered by a specific card service provider or mobile device. However, it will be appreciated that other techniques may be utilized to enable and disable a virtual card.

Different methods may be used to effect a state change for a virtual card as it is toggled between an enabled state and a disabled state (or vice versa). In some systems, the state change may be effected by user action and/or in other systems, the state change may be automatic, or semi-automatic, based on use or access to a virtual card. For example, the state change may be due to one or more of the following example actions: changing pin code, changing password, changing expiration date, toggling switch, remove value and then restore value, time-based rules, security rules, usage rules. Also, actions such as user confirmation actions or request for use may operate to toggle the card between the disabled and enabled state.

In one example, a user action such as requesting use of a virtual card may trigger the toggling of the status of the card. Further, in some embodiments, an action such as flipping an electronic card over or accessing a bar-code region or other code may trigger the toggling of the status of the card. For example, in some embodiments, a virtual card may be presented on the user computing device and an action such as flipping the card over electronically may enable a user to “see” the reverse side of the card where a barcode or other use information may be stored. The action of flipping the card over may trigger the enabled state. The card may then remain in the enabled state for a predetermined period of time such that failure to use the card during a defined period of time results in the card toggling back to the disabled state. In other embodiments, once enabled, the card may stay in the enabled state indefinitely or until another action, such as a closing of the virtual card occurs or a time limit is reached.

As another example, periodically authenticating by selectively enabling a virtual card transaction may include changing PIN/CID codes associated with the virtual card included in the manager-side associative card profile. For example, a code associated with a virtual card included in the manager-side associative card profile may be changed intermittently so that only the virtual card manager knows or can identify the corresponding code. For example, the code may be sent to the virtual card engine when periodic authentication is turned ON. The code may be changed when periodic authentication is turned back OFF. This creates a method of temporarily enabling and disabling these cards. As another non-limiting example, a virtual card state indicator may be provided. For example, the virtual card manager and/or card service provider may include a virtual card state indicator or flag that can temporarily disable use of a card without deactivating the card. As an even further example, a card service provider may work with the virtual card manager to develop or use a method specifically for toggling the user of the virtual card relative to access of the virtual card via the virtual card engine. It will be appreciated that the aforementioned selective enablement techniques are exemplary in nature and other selective enablement techniques may be utilized in other examples.

As a further example, a virtual card may be delivered to a mobile computing device. The state of the card upon initial delivery may be controlled such that the card is issued in a first state, such as an enabled state or disabled state. The state of the card may then be toggled depending on the authentication rules. The authentication rules may include rules of when toggling is triggered, time periods for retaining a specific state, identification triggers, etc. The authentication rules may include rules set by the virtual card manager based on a desired security level requested by the card service provider and/or the goods and services system as well as rules set directly by the card service provider and/or the goods and services system. The rules may further be enhanced or limited based on a user's computing device.

Additionally, in some examples, the enablement module may be further configured to selectively enable a second virtual card based on a second set of predetermined authentication rules 219, the first and second sets of predetermined authentication having different characteristics. Thus, different sets of authentication rules may be applied to different virtual cards or groups of virtual cards. Further in some examples, the first set of predetermined authentication rules may be adjusted (e.g. established) via a first card service provider and/or a first goods and services system and the second set of predetermined authentication rules may be adjusted (e.g. established) via a second card service provider and/or a second goods and services system. However, in other examples, the first and second sets of predetermined authentication rules may be adjusted via the first goods and services system and/or the first card service provider. Still further, in other examples, the virtual card engine may adjust at least a portion of authentication rules including the first and/or second set of predetermined authentication rules. However, in other examples, the virtual card engine may be inhibited from adjusting predetermined authentication rules. Therefore, the way in which a virtual card or a group of virtual cards is selectively enabled may be tailored to the specifications of a particular goods and services system, card service provider, and/or virtual card engine.

In some examples, the authentication rules may include a persistent enablement rule in which a virtual card is set in a permanently enabled state. A goods and services system and associated card service provider may utilize such a rule when a high level of virtual card security is not desired, such as when the virtual card is a rewards or loyalty card. In this way, a goods and services system and/or card service provider may adjust the level of security based on the type of virtual card in use.

Further in some embodiments, the authentication rules may include an access rule in which the virtual card is set in an enabled state in response to access of the virtual card in the virtual card engine. For example, in some systems, selective enablement may be triggered when a virtual card is opened for viewing on a mobile computing device that is capable of this type of security (whereas it might not be enabled if delivered to an incapable device). In other systems, flags may be triggered where a card may be in a high risk situation for fraud (e.g. repeated attempts to use a virtual card, multiple attempts to use the card in a predefined period, etc.). Additionally, the authentication rules may further include a cessation rule in which the virtual card is set in a disabled state in response to cessation of a virtual card transaction. In this way, a virtual card may be enabled prior to a transaction and disabled after a virtual card transaction has been completed, increasing the security of the system. It will be appreciated that a cessation time interval may be established, in some embodiments. For example, the goods and services system may establish a threshold time interval (e.g. 1 minute, 20 minutes, etc.) that may trigger disablement after a transaction has been completed.

The authentication rules may further include a card fulfillment rule in which selective enablement is adjusted based on the system utilized to perform an initial configuration of the virtual card, the system including one or more of an internet-based configuration system, a goods and services system, and a mobile configuration application executed on a mobile computing device. In this way, security of the virtual card may be increased when a virtual card is generated from a less trustworthy source. For example, there may be more potential for fraudulent action when a virtual card is generated utilizing an Internet-based configuration system, therefore selective enablement of the virtual card may be triggered after a multiple levels of authentication have been implemented. For example, a user of the virtual card engine may be prompted to enter a password to selectively enable use of the virtual card. Additionally, the virtual card manager may confirm that one or more unique card identifiers of the virtual card correspond (e.g. match) to the unique card identifiers stored within a manager-side associative card profile to implement selective enablement. Furthermore, the aforementioned security measure may be implemented multiple times during a virtual card transaction to decrease the chance of fraudulent card use.

Similarly, the authentication rules may include a redemption rule in which selective enablement is adjusted based on the location of redemption (e.g. the location where the virtual card transaction is carried out). The location of redemption may be one of a brick and mortar store or a merchant's website.

The authentication rules may further include a card type rule in which selective enablement is adjusted based on the type of virtual card in use, the types of cards including one or more of a gift card, a membership card, and a rewards card. For example, a goods and services system may want to increase the level of security when a virtual gift card is in use and decrease the level of security when a rewards card is in use. As discussed above, a user of the virtual card engine may be prompted to enter a password to selectively enable use of the virtual card when a virtual gift card is used. Additionally, the virtual card manager may confirm that one or more unique card identifiers of the virtual card match the unique card identifiers stored in a manager-side associative card profile to implement selective enablement when a virtual gift card is used. However, when a virtual rewards card is used, the virtual card may be permanently enabled or the virtual card manager may implement selective enablement after it is confirmed that one or more unique card identifiers of the virtual card match the unique card identifiers stored in a manger-side associative card profile when a virtual rewards card is used. In this way, each type of virtual card may have varying levels of security.

Furthermore, the authentication rules may include a rule that may adjust selective enablement of a virtual card transaction based on the location of the virtual card engine (e.g. mobile phone). For example, an increased level of security may be implemented when the virtual card engine is a web-based application and a decreased level of security may be implemented when the virtual card engine is executed on a mobile computing device.

Other exemplary authentication rules include a time-based rule for the use of a virtual card. In some embodiments, the time-based rule may be a foundation or base rule which requires at least some definition by the goods and services system and/or card service provider. For example, the goods and services system may define that the virtual card must be used within a select period of time (e.g. within 5, 10, 15, 30, 60, 90 minutes, etc,) after having been enabled, otherwise it may be automatically disabled.

Other exemplary authentication rules include a usage rule. For example, in some embodiments, a virtual card can only be used a select number of times (e.g. 1, 2, 3, 4, 5, etc.) within a specified time period. As another non-limiting example, a goods and services system may select to permanently disable a virtual card after a single use.

A goods and services system may further determine various card identification and security identification (CID) rules. These rules may enable the goods and services system to have some control over the authentication process. For example, the goods and services system may define the size of a security code identifier, and rules around the use of that CID relative to managing authentication with the card service provider.

Further, in some embodiments, the goods and services system may define rules related to the card holder's mobile computing device. For example, a goods and services system may define rules that enable virtual card to be allowed for use from multiple mobile/electronic devices or limit such use to a single device. As such, in some embodiments, a user may be able to transfer a virtual card form one device to another device or to a different user. In other embodiments, such transfer functionality may be turned off or minimized. Moreover, limits may be placed on the number of devices enabled to present a single virtual card. In some systems, a goods and services system may enable cards to be combined to create single cards with greater value. Further some systems may enable a card to be split into separate lower value cards which may or may not be transferred to another mobile device or user depending on the goods and services system rules as defined by the goods and services system.

As another example, card-holder setting authentication rules may be defined by the goods and services system. For example, goods and services systems may choose to enable the virtual card engine to modify some of the rules set by the goods and services system. For example, a goods and services system may default to higher security for their virtual cards, but may allow a virtual card engine to select to not participate in that higher level of security.

It will be appreciated that the card service provider and/or goods and services system may select one or more of the aforementioned authentication rules for use in the virtual card manager. However, numerous authentication rules are possible, therefore additional or alternate authentication rules may be selected for use in other embodiments.

FIG. 2B shows an exemplary use case of the enablement module according to an embodiment of the present disclosure. As depicted, enablement module 215 may set or enable triggering of a virtual card 250 between an enabled or disabled state. However, the virtual card may have an “activated” status. Thus, use of the virtual card may be quickly turned “on” and “off” without modifying the status of the virtual card (e.g. deactivating). The activated status of the card may indicate that the card is available for use, such that there is stored value on the card that is available for use. In some examples, where the virtual card is a virtual membership card, an activated card may be a card that is issued and the value in terms of privilege value is available. The enablement module does not affect the stored value on the card, but instead manages the usability of the card.

Returning to FIG. 2A, the virtual card management platform may further include an associative profile module 216. The associative profile module may be configured to manage at least one manager-side associative card profile 34. Each manager-side card profile may have a corresponding virtual card as well as a corresponding provider-side associative card profile. The manager-side associative card profile may include card data such as one or more identification numbers, passwords, client data, etc., as well as data corresponding to the state of the virtual card, in some embodiments. Additionally, the virtual card management platform may include an application program interface (API) 218 or other suitable software communications standard communicatively linked to the e-commerce service. Thus, the API may serve as an interface between the virtual card manager and the e-commerce service.

Virtual card management platform 210 may further include an administration module 220 configured to adjust the authentication rules, the manager-side associative card profile, and/or other card service which may be provided by the virtual card manager. The card service provider, goods and services system, and virtual card engine may be granted access to at least a portion of functions performed by the administration module. However, it will be appreciated that in some embodiments only the card service provider and/or goods and services system may have access to the administration module. Further still in some embodiments, the virtual card manager may only have access to the administration module. In this way, security of the virtual card management system may be enhanced.

Virtual card management platform 210 may also include a usage module 222 configured to track virtual card usage data 224, such as card transactions, authentication events, etc., of the virtual cards which interact with the virtual card manager. In this way, usage data may be gathered for a large number of cards that may be used for subsequent evaluations of the virtual card management system. The usage data may also be used for marketing purposes. The virtual card manager may include a repository (e.g. database) for storing card transaction information and data such as the usage data as well as the manger-side associative card profiles. However in other examples, the usage data and the manger-side associative card profiles may be stored on the server(s) 202.

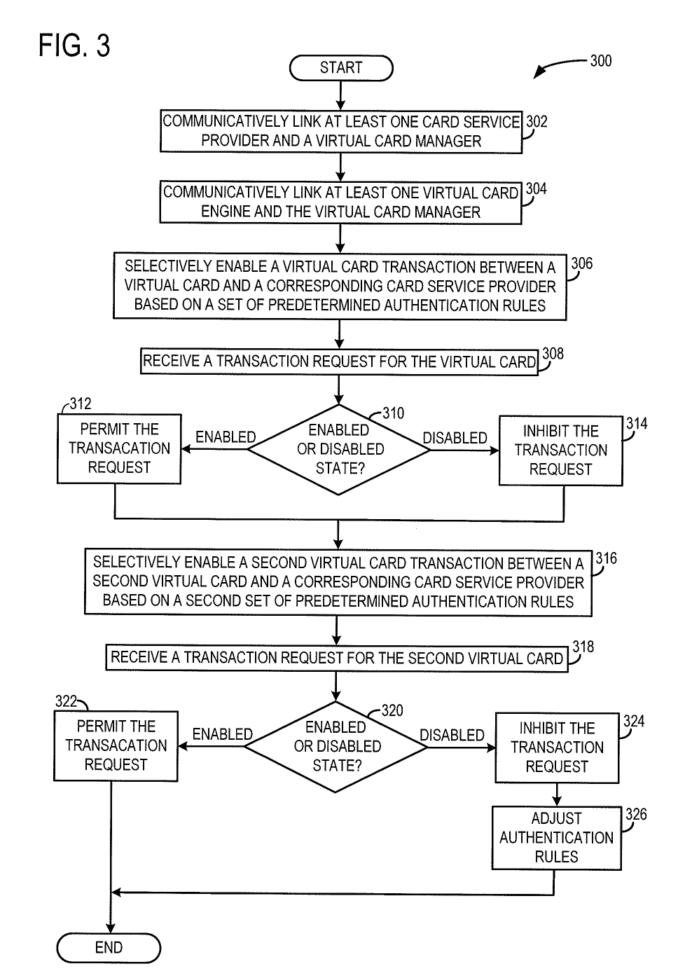

FIG. 3 shows an exemplary method 300 which may be used to selectively enable one or more virtual cards. It will be appreciated that the method may be implemented utilizing the systems, devices, etc., described above. However, in other embodiments, method 300 may be implemented utilizing other suitable systems and devices.

First at 302 the method includes communicatively linking at least one card service provider and a virtual card manager. Next at 304, the method includes communicatively linking at least one virtual card engine and the virtual card manager. As such, a user may be issued a virtual card to their mobile computing device and/or other device such that the virtual card may be accessible through the mobile computing device. It should be appreciated that the examples provided herein are discussed in regards to delivery of the virtual card to a mobile computing device, however, in some systems, the methods may be initiated on a stationary computing device, such as for an internet based order. Thus, periodic authentication may be initiated and utilized from any networked computing device, mobile or stationary.

In one example, a virtual card may be requested from a merchant who may send a virtual value card directly to a user's mobile computing device. The user may store the virtual value card in their electronic wallet until they are ready to use the card. As discussed below, the security of the card may be enhanced through management of the state of the card (enabled versus disabled). Toggling of the card between an enabled state and disabled state may be based on authentication rules, such as predetermined authentication rules. The implementation of the rules, and thus management of the state of the card, may be handled remotely such as through a remote virtual card manager, and/or depending on the rules, on-board, such as through the mobile computing device. With examples where the state of the card is handled through the mobile computing device, an application with the rule set may be loaded onto the mobile computing device.

At 306 the method includes periodically authenticating by selectively enabling a virtual card transaction between a virtual card and a corresponding card service provider based on a set of predetermined authentication rules. For example, a period for authenticating may be set by predetermined authentication rules. For example, the period may be based on attempted use, a predetermined time period, display or selection to display a virtual card, etc. As previously discussed, periodically authenticating a virtual card transaction may include setting the virtual card in an enabled state or a disabled state, the disabled state includes a state in which a virtual card transaction between the virtual card and the card service provider is inhibited and an enabled state including a state in which a virtual card transaction is permitted. In this way a transaction may be allowed or disallowed based on a set of predetermined authentication rules. Furthermore in some embodiments, periodically authenticating by selectively enabling may further include modifying one or more characteristics of the manager-side associative card profile to enable or disable a transaction between at least one virtual card service provider and at least one virtual card, the characteristics including at least one of a virtual card state indicator and a unique card identifier associated with a virtual card.

Further in some embodiments, a virtual card transaction may include a value transaction in which a virtual card value within the provider-side associative card profile and/or the virtual card is adjusted or a privilege transaction in which privileges data within the provider-side associative card profile is accessed and/or adjusted. Still further in some embodiments, setting the virtual card in an enabled state may trigger periodic authentication of the virtual card. Periodic authentication may include correlating one or more unique card identifiers included in at least one of the virtual card and a provider-side associative card profile with unique card identifiers included in the manager-side associative card profile.

Next at 308 the method includes receiving a transaction request for the virtual card. The transaction request may be a use request, such as a request to use the stored value on the card. As discussed previously, the stored value may be monetary value such as is in virtual gift card or may be privilege value, such as in a membership card.

At 310 it is determined if the virtual card is in an enabled or disabled state. In some examples, determining if the virtual card is in an enabled or disabled state may include implementing an authentication procedure, such as periodic authentication. Periodic authentication may be based on the predetermined authentication rules and may include toggling the card between an enabled and disable status at one or more select times. The toggling may be triggered by an event associated with the card, such as attempted use, status of the virtual card (e.g. display of the virtual card on the user's mobile computing device), etc. The authentication procedure may be carried out via communication between the virtual card manager, the card service provider, and/or the virtual card engine. If the virtual card is in an enabled state (e.g. if authentication is confirmed) the method proceeds to 312 where the method includes permitting the transaction request. However, if the virtual card is in a disabled state (e.g. if authentication failed) the method proceeds to 314 where the method include inhibiting the transaction request.

It should be appreciated that the method may end at 312 or 314. Further, although a second transaction is discussed with a second set of predetermined authentication rules at 316, it should be appreciated that the second set of predetermined authentication rules may be different than the first set of predetermined authentication rules or identical to the first set.

Next at 316 the method includes selectively enabling a second virtual card transaction between a second virtual card and a corresponding card service provider based on a second set of predetermined authentication rules. It should be appreciated that the method at 316 can occur concurrently with the first part of the method.

At 318 the method includes receiving a transaction request for the second virtual card. At 320 it is determined if the second virtual card is in an enabled or disabled state. In some examples, determining if the second virtual card is in an enabled or disabled state may include implementing an authentication procedure. The authentication procedure may be carried out via communication between the virtual card manager and the card service provider and/or the virtual card engine. If the second virtual card is in an enabled state (e.g. if authentication is confirmed) the method includes at 322 permitting the transaction request. However, if the second virtual card is in a disabled state (e.g. if authentication failed) the method proceeds to 324 where the method includes inhibiting the transaction request. In some examples, the method may further include at 326 adjusting the authentication rules in response to the authentication failure between the virtual card engine and the virtual card manager. In this way, the security of the virtual card may be increased when a third party is suspected of attempted fraudulent use of the virtual card. However, in other embodiments step 326 may not be included in method 300. After 322 and 326 the method ends. In this way, a virtual card may be quickly enabled and disabled, enhancing the security of the virtual card management system and decreasing the chance of fraudulent use of a virtual card by a third party.

As described above, a method is provided where a virtual card is issued to a user and may be accessed through a mobile computing device. To enhance security, the virtual card may be managed such that the card may be toggled between an enabled and disabled state. In contrast to prior systems, where a gift card is available for use by anyone that holds the gift card, the described method provides periodic authentication to enable a select level of identification of the user of a virtual card. The level of authentication may be based on the merchant's system, the predetermined authentication or security rules, and/or the user computing device. The management of the state of the card (toggling between an enabled state and a disabled state) increases the security level of a virtual card. It should be appreciated that the management of the state of the card may be handled by a remote server through a communication link, such as the Internet, such that the virtual card manager is a remote server. In other systems, the management of the state of the card may be handled directly or at least partially by the mobile computing device associated with a virtual card. As such, in some examples, the virtual card manager may be retained on the mobile computing device or at least partially on the mobile computing device.

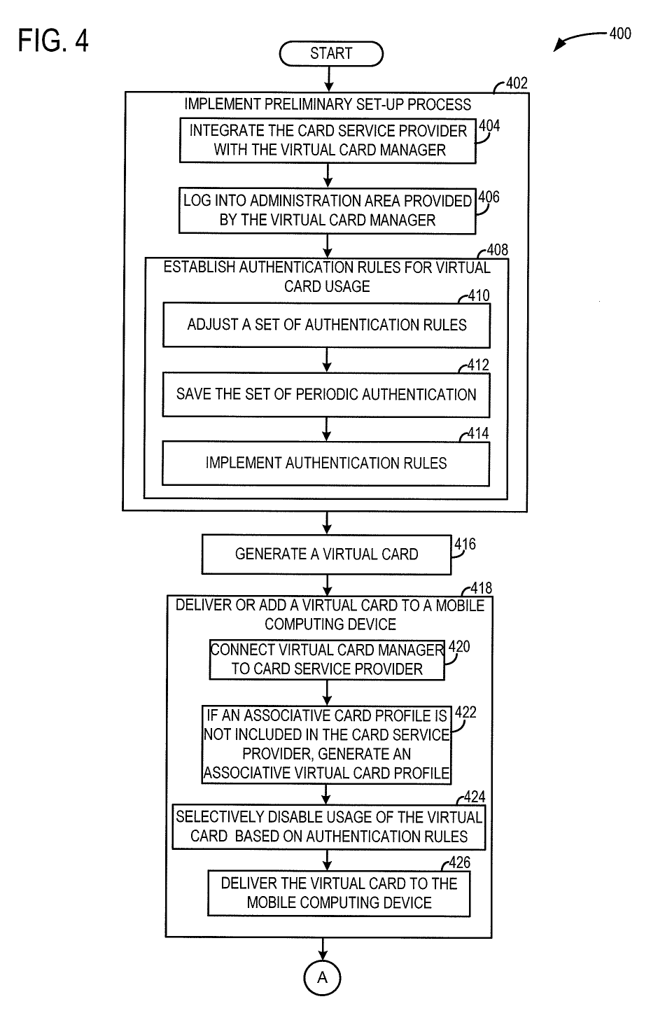

Turning now to FIG. 4, an example process flow of a method 400 for managing a virtual card according to an embodiment of the present disclosure is shown. It will be appreciated that the process flow is exemplary in nature and that numerous other process flows may be used in other examples. A preliminary set-up process is implemented at 402. The preliminary set-up process may be implemented before a goods and services system is given the ability to process virtual cards from a mobile computing device. The preliminary set-up process may include at 404 integrating the card service provider with the virtual card manager. Integration may be accomplished in a number of ways. In one example, the card service provider may have an Application Program Interface (API) or other method allowing the virtual card manager to communicate with the card service provider. In such an example, the virtual card manager may use an integration connector engine to link the software systems included in the virtual card manager with the card service provider API or other software communication standard. However, in other embodiments, the card service provider may use an API or other software provided by the virtual card manager. In further examples, the card service provider may provide the virtual card manager with other methods or systems for communication.

Next, at 406, the method includes logging into an administrative area provided by the virtual card manager. For example, the goods and services system and/or the card service provider may be given access to an administration module configured to adjust one or more authentication rules, discussed above with regard to FIG. 2A. Therefore, at 408, the method includes establishing authentication rules for usage of the virtual card as well as other rules. Thus, a user (e.g. virtual card manager representative, card service provider representative, goods and services system representative) may set up the authentication rules. However, in other examples, the authentication rules may be automatically established. In this way, customization of authentication rules of the virtual cards for each goods and services system and/or card service provider may be provided. Thus each goods and services system and/or card service provider may tailor the virtual card management system to fit their specific needs.

Establishing authentication rules for virtual card usage may include at 410 adjusting a set of authentication rules, at 412 saving the authentication rule set, and at 414 implementing the authentication rules. Thus in some examples, one or more virtual cards may be authenticated per the authentication rule set established via the goods and services system and/or card service provider. The virtual card manager may manage translation of the authentication rules per the card service provider and/or goods and services system authentication rule set and the card service provider capabilities. As previously discussed the authentication rules may dictate the way in which a virtual card is selectively enabled.

Next at 416, the method includes generating a virtual card. A virtual card may be generated online, at a brick and mortar location corresponding to the goods and services system, or on a mobile computing device. It will be appreciated that when a virtual value card (e.g. virtual gift card, or virtual rewards card) is generated monetary value corresponding to the virtual gift card may be generated within the virtual card management system. Additionally, generation of a virtual card may further include, generating identification characteristics, such as an identification number, a barcode, an identification image (e.g. picture of the card user), card privileges, etc.

It should be appreciated that in an exemplary embodiment, the virtual card manager may set the card in a temporarily disabled state when the virtual card is generated (e.g. issued). As previously discussed the virtual card may be in a disabled state but be an “active” virtual card. Temporarily disabling the virtual card may protect a card-holder from fraudulent use. Moreover, when the virtual card may be access via the virtual card engine, presented to a goods and services system, etc., the virtual card engine may be in communication with the virtual card manager to set the virtual card in an enabled state just prior to use of the virtual card.

At 418 the method may include delivering (e.g. adding) a virtual card to a virtual card engine on a mobile computing device. It will be appreciated that in other examples, the virtual card engine may not be included in the mobile computing device. It is important to note that utilities may be provided through the POS software, card service provider, or other remote or local based application to allow the goods and services system the ability to quickly and easily deliver the virtual card to the virtual card engine and therefore the mobile computing device. The goods and services system may also deliver a tangible based representation of the virtual card (e.g. a standard plastic card) to the user that can then be transferred onto their mobile computing device from the mobile device software.

Delivering the virtual card to a virtual card engine on the mobile computing device may include connecting the virtual card manager to the card service provider at 420. If a provider-side associative card profile is not included on the card service provider the method may include at 422 generating a provider-side associative card profile. Furthermore, delivering the virtual card to the virtual card engine may further include at 424, selectively disabling use of the virtual card based on authentication rules established via the goods and services system and/or card service provider and at 426 delivering the virtual card to the mobile computing device via a link or code to email, Extensible Markup Language (xml), Short Message Service (sms), an mmx instruction, Wireless Application Protocol (wap), various open ports or other suitable software code or links.

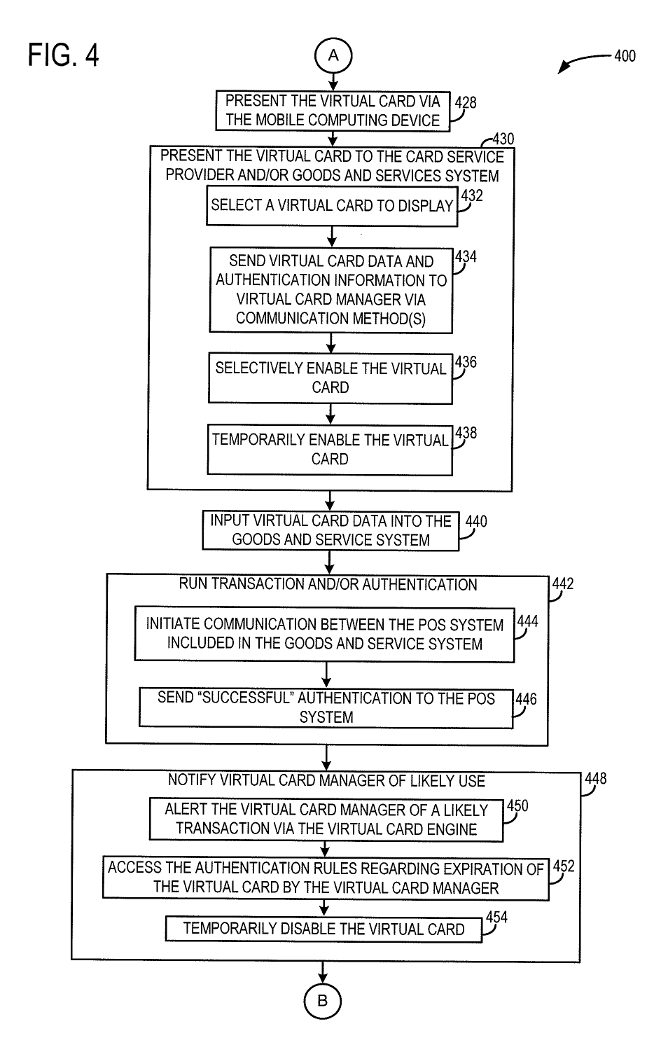

FIG. 5 shows a depiction of a method which may be used to generate a virtual card and send the virtual card to a mobile computing device. It will be appreciated that a mobile computing device may include a personal computer, a laptop computer, a portable media player, etc., as discussed above.

At 502, the method includes requesting a virtual card for delivery. The request may be made at a brick and mortar location associated with a goods and services system, on a mobile computing device, over the Internet, or by another suitable system. In some examples, requesting a virtual card may include transferring card data from a plastic card into a virtual card engine.

At 504, the method including determining if the goods and services system requires authentication of the virtual card prior to delivery. A requirement of authentication may be dictated via a set of predetermined authentication rules established via the goods and services system and/or the virtual card manager. If the goods and services system does not require authentication of the virtual card prior to delivery (NO at 504), the method advances to 506 where the method includes delivering the virtual card to the virtual card engine (e.g. mobile computing device). In some examples, the virtual card manager may automatically add virtual card data to a manager-side associative card profile or account in response to delivery of the virtual card.

However, if the goods and services system does require authentication of the virtual card prior to delivery (YES at 504), the method includes at 507, receiving identification data (e.g. authentication data) corresponding to a mobile computing device and at 508 transferring the identification data to the mobile computing device, a goods and services database, and/or the virtual card manager. The identification data may include a phone number, an email address, authentication information, a unique identifier (e.g. identification number), etc. Additionally the goods and services database may be executable software. For example, the goods and service database may include at least one of a POS system interface, a web interface, a card service provider interface, and other software that may be configured to communicate identification data. It will be appreciated that when a request for delivery of a virtual card is made from the mobile computing device which is the intended recipient of the virtual card, it is assumed that an account has already been created within the virtual card manager and therefore the identification information is not sent to the virtual card manager, in such an example.

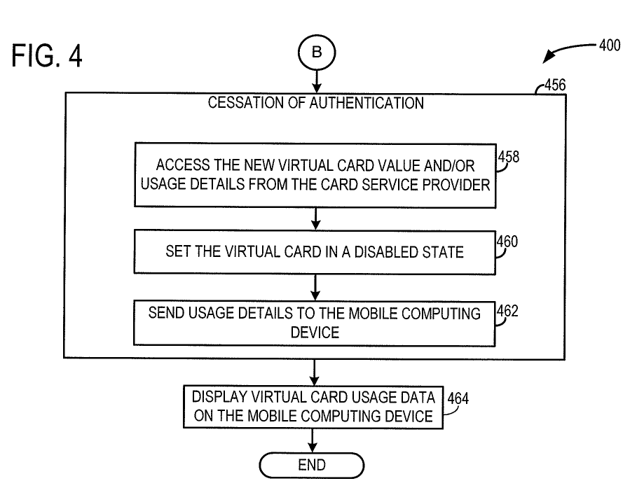

Next at 510 the method includes determining if the identification data is recognized via the virtual card manager. The determination of the recognition may be based on a set of predetermined authentication rules and/or the capabilities of the card service provider. If the identification data is not recognized by the virtual card manager (NO at 510) the method proceeds to 512 where it is determined if the virtual card can be viewed without setting up a virtual card engine. If the virtual card cannot be viewed without setting up a virtual card engine (NO at 512) the method advances to 514 where the method includes enabling the set-up of a virtual card engine. Enabling the set-up of a virtual card engine may include sending an attachment or link through and email or other suitable message service to the portable computing device. However, it will be appreciated that alternate techniques may be used to enable the set-up of the virtual card engine. For example, the virtual card engine may be mailed via a physical mail service. Next at 516 the method includes setting up the virtual card engine on the mobile computing device. An exemplary method which may be utilized to set up the virtual card engine on a mobile computing device is illustrated in FIG. 6, discussed in more detail herein.

If the identification data is recognized by the virtual card manager (YES at 510), if the virtual card can be viewed without setting up a virtual card engine (YES at 512), or after 516 the method includes at 518 determining if the virtual card should be set in a disabled state. As previously discussed a disabled state may be a state in which use of the virtual card is inhibited.

If it is determined that the virtual card should be set in a disabled state (YES at 518) the method proceeds to 520 where the method include disabling the virtual card. After 520, the method proceeds to 506. However, if it is determined that the virtual card should not be set in a disabled state (NO at 518) the method proceeds to 506.

It will be appreciated that the virtual card may be set in a disabled state based on the set of authentication rules established or adjusted via the mobile computing device, the goods and services system, and/or the card service provider system. As previously discussed, the authentication rules may include one or more of a persistent enablement rule, an access rule, a card fulfillment rule, a redemption rule, a card type rule, and a time-based rule.

FIG. 6 shows a depiction of a method which may be used to set up a client based or browser based virtual card engine. A client based virtual card engine may be stored, accessed, and executed on a mobile computing device. On the other hand, a browser based virtual card engine may be accessed via a browser over the Internet or other suitable networking system.

At 602 it is determined if a virtual card engine should be set up on a mobile computing device. If it is determined that the virtual card engine should not be set up on the mobile computing device (NO at 602) the methods ends. However, if it is determined that the virtual card engine should be set up on the mobile computing device (YES at 602), the method proceeds to 604 where the method includes determining if the virtual card engine is executed via a browser or a client. In other words, it is determined if the virtual card engine is executed as a web-based application or a client-side application.

If it is determined that the virtual card engine is executed via the client (e.g. mobile computing device) the method advances to 606 where the method includes loading the virtual card engine onto the mobile computing device. The virtual card engine may be downloaded via the Internet, uploaded via an interface of the mobile computing device (e.g. Universal Serial Bus port, CD-ROM drive, etc.), etc. For example, a virtual card engine link may be provided in an email. The link may notify the user of instructions on adding that virtual card engine to their mobile computing device. This may include installation of the virtual card engine to that mobile computing device prior to the virtual card being viewable on that device (depending on the rules surrounding that virtual card for that goods and services system.

In some examples, the virtual card engine may be keyed to installation of the virtual card engine on the device. In one example, unique and/or encrypted unique keys may be stored in the manager-side associative card profile or other suitable repository within the virtual card manager and may be connected to an associated virtual card engine. Identifying the specific installation or using other unique keys made available on the mobile software platform to distinguish the virtual card engine as coming from that device may be employed.

However, if it is determined that the virtual card engine program is executed via a browser the method advances to 608 where a browser based virtual card engine is accessed via the Internet or other suitable network.

After 606 and 608 the method advances to 610, where the method includes establishing a user identity, such as a user name and/or password. An authentication code may be issued to verify the virtual card, user account and/or mobile computing device. In some examples, a phone number or other suitable identification data within the virtual card manager corresponding to the mobile computing device may be checked against a phone number or other identifying data of the mobile computing device in use. Each goods and services system may set different levels of authentication. For example, an authentication code may be issued to email to verify the email account. An authentication code may be further issued to the mobile computing device with account setup information. As such the code may be issued through a phone, through an SMS or MMS message, etc. In even other examples, an authentication code may be issued to a mail account, such as a conventional paper mail address, to establish certain levels of membership. Furthermore, in other examples, a user may be required to do none of the above authentications. Authenticating the users to this level in the virtual card engine may allow easy establishment of a membership card or other virtual card on behalf of a goods and services system from the mobile computing device because the user (e.g. the user's mobile computing device) has already been pre-authenticated.

Next at 612 the method includes issuing an authentication code to verify the account within the virtual card manager (e.g. manager-side associative card profile). The authentication code may be issued to the mobile computing device, in some examples. Verification may include checking stored information corresponding to the mobile computing device on file with a code identifying the request. In this way, verification of the virtual card as belonging to a user's mobile (or stationary) computing device can be achieved.

Next at 614 the method includes implementing a verification procedure. Implementation of the verification procedure may include logging into an account within the virtual card manager (e.g. manager-side associative card profile) and verifying the account via entering the security code into the mobile computing device.

Next at 616 the method includes determining if the account has been verified. In some examples, verification of the account includes logging into the account and entering the issued security code. However in other example, alternate techniques may be used to verify an account.

If it is determined that the account has not been verified (NO at 616) the method advances to 618 where the method includes inhibiting the use of the virtual card. After 618 the method ends. However, if it is determined that the account has been verified (YES at 616) the method advances to 620 where use of the virtual card is permitted. In some examples, capabilities may be offered from the virtual card engine to potentially purchase, add value to, transfer the rights of, or transfer plastic to virtual cards when use of the virtual card is permitted.

Next at 622 the method includes tracking the mobile computing device via the virtual card manager. Tracking the mobile computing device enables the virtual card manager to identify the mobile computing device as the mobile device and user that has been authenticated. Depending on the goods and services set of authentication rules, the goods and services system may require that a user has authenticated from the same mobile computing device which requests use of the virtual card downstream. Once the account is setup and authenticated, the virtual card engine may receive virtual cards which require any level of authentication. Thus, once a card holder has been added, periodic authentication may be used to verify that a person using a virtual card, such as a membership card, is doing so from a device that was qualified to do so based on the verification processes discussed above.

As such, in one example embodiment, when a user uses a browser-based virtual card engine, the virtual card manager may associate the account with the mobile computing device that the virtual card engine was set up on. The association may occur through use of a cookie, Internet protocol (IP) address or other unique identifications that can be placed on that mobile computing device. The virtual card manager may look for that cookie (encrypted key within the cookie), IP address or other unique identification that will tell the virtual card manager that the mobile computing device being used is the mobile computing device that setup the account. For example, the virtual card manager may store encrypted or non-encrypted keys on the mobile computing device that are sent to the virtual card manager when the account was established and then later sent each time a request for authentication occurs. Thus, in some embodiments, only a qualified device may be able to authenticate the virtual card, reducing and/or eliminating the redemption of a fraudulent virtual card.

In some examples, if a user attempts to login to an account (e.g. manager-side associative card profile) from a mobile computing device that is not recognized by the virtual card manager, the user may be requested to perform additional methods of identification. These additional identification methods may include answering security questions that the user may have established at the time of their initial account setup. In some embodiments, the non-recognition of the mobile computing device may result in the user having to reestablish the user through the previously described methods a second time. The user may be asked if they wish to change their security to that mobile computing device or re-establish the mobile computing device as connected to their account (e.g. manager-side associative card profile). It is also possible that the user may be holding cards that do not require authentications at the level where they are connected to the mobile computing device but rather just connected to their account. If this is the case, then such virtual cards may be available from other mobile computing devices than the mobile computing device to which the account is connected to in a manager-side associative card profile or other suitable repository for storage of virtual card data. It is also possible that a virtual card may be accessed by two separate virtual card engines. Such as a husband and wife that share the same Safeway rewards card for membership privileges.

Under the browser model, the user may add a virtual card to their “Favorites” on their mobile computing device to quickly and effectively open that virtual card from that mobile computing device. They may also wish to issue a link via SMS or MMS to their phone to enable them to quickly pull that virtual card from their browser. Under this situation the “favorite” link added may have logic involved that looks at the security specified by the goods and services system of that card and determines if the user can view the virtual card immediately without authentication, view the virtual card immediately (with the virtual card manager system noticing the cookie that represents they are viewing from their account-related device), view the virtual card but have to authenticate username and password, and/or view the virtual card but have to authenticate and the device must be the device associated to their account in a manager-side associative card profile or other suitable repository.

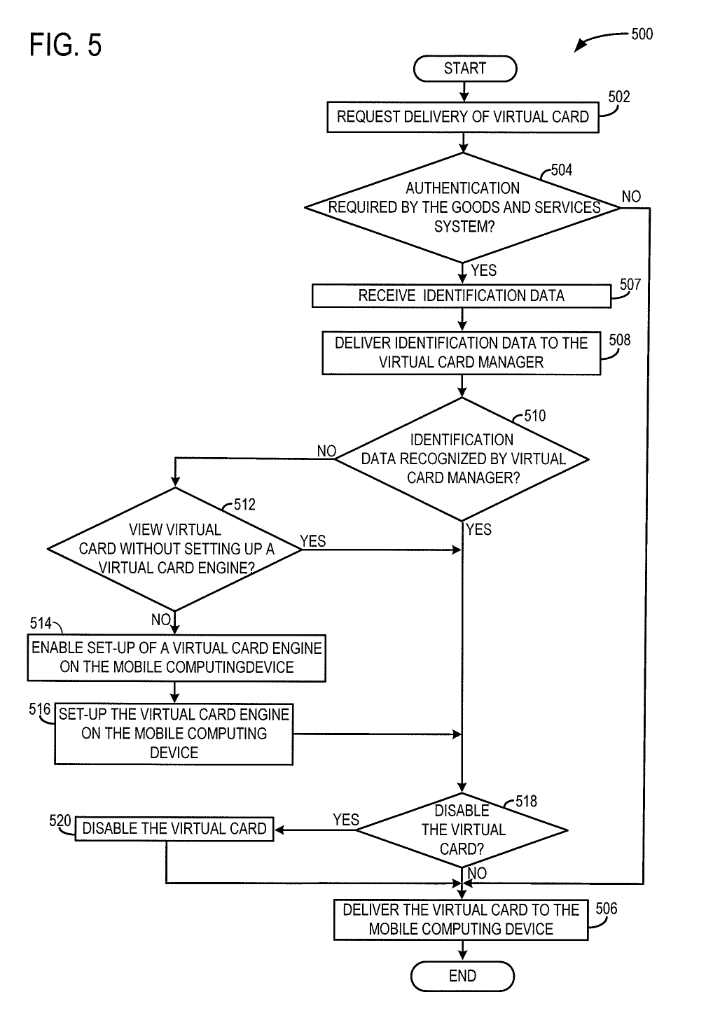

Returning to FIG. 4, at 428 the method including presenting the virtual card on a display of a mobile computing device, such as a mobile phone. Therefore, a user may access the virtual card via the virtual card engine and view the virtual card. FIGS. 7-9 illustrate an exemplary mobile computing device 700 including a display 702. The mobile computing device may further include suitable input devices, such as a touch screen 704 and various buttons 706, allowing a user to manipulate the mobile computing device. It will be appreciated that in some examples, the touch screen may present a keyboard to facilitate alpha-numeric input. It will be appreciated that various buttons, touch inputs, etc., may be used to navigate between the content windows depicted. For example, a “back” button may be provided to allow a user to navigate to a previous window and a “plus” button may be provided to navigate to a content window that is configured to add a virtual card to a virtual card engine. Furthermore, a touch input performed above various graphics, icons, etc., may enable access of the features corresponding to the selected graphic or icon.

The mobile computing device may further include a virtual card engine stored in memory for achieving the functionality described above via one or more processors. The memory, processor, as well as additional electronic componentry may reside within or on-board a device body 708 of portable computing device 700. However, in other examples, the virtual card engine may be accessed via a browser. The virtual card engine may be configured to present a plurality of virtual cards as well as modify the arrangement of the virtual cards and the appearance of the virtual cards on the display.

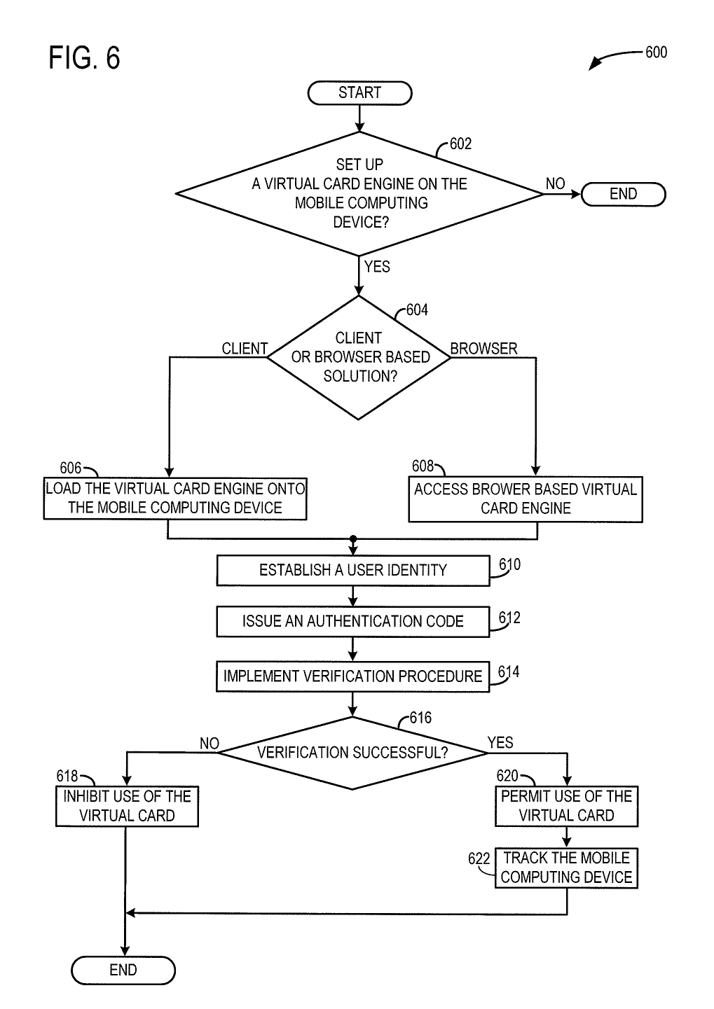

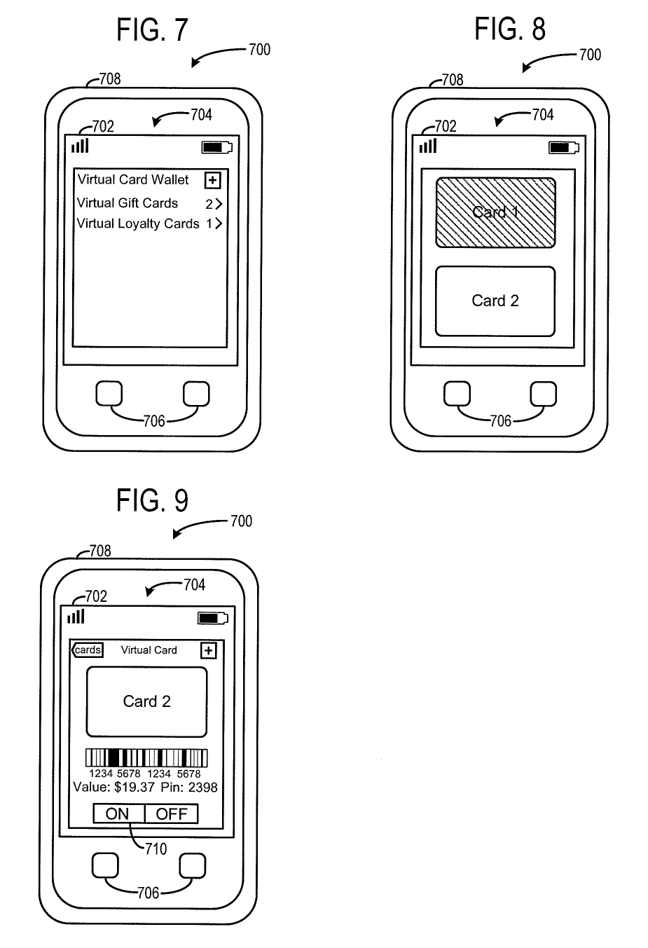

As an example, virtual cards may be organized on a display according to a card type (e.g. virtual gift cards, virtual loyalty cards), as depicted in FIG. 7. In other systems, the cards may be organized based on merchant, on date for use, etc. A user may select the virtual gifts cards, therefore the virtual gifts cards may be presented on the display, as depicted in FIG. 8. Thus, the user may sort through a number of virtual cards. Then the user may select a specific virtual card for viewing. The selected virtual card may be presented on the display with virtual card information such as a personal identification number (PIN), the value of the virtual card, a barcode, the state of the virtual card (e.g. on or off), etc., as depicted in FIG. 9. In some examples, a user may adjust the state of the virtual card via a button 710 on the touch screen or other suitable input device. In this way, a user may select enablement of the virtual card, thereby triggering selective enablement (e.g. setting the virtual card in an enabled state) within the virtual card manager. Alternatively in other embodiments, the state of the virtual card may just be presented on the display and manipulation of the state of the virtual card via user interaction may be inhibited. Furthermore, it will be appreciated that additional techniques may be used to trigger selective enablement. For example, when the virtual card is accessed (e.g. selected) for viewing on the mobile computing device selective enablement may be triggered, thereby setting the virtual card in an enabled state.

Returning to FIG. 4, after viewing the virtual card via the mobile computing device, method 400 may include at 430 presenting the virtual card to a card service provider and/or a goods and services system. The virtual card may correspond to the card service provider and/or the goods and services system. That is to say that card data (e.g. ID numbers and value data) associated with the virtual card may be stored and/or accessed via the card service provider and/or goods and services system.

As a non-limiting example, presenting the virtual card to a card service provider and/or a goods and services system may include at 432, selecting a virtual card to display to the goods and services system. In some examples, after a virtual card is selected a message asking for verification of intended use of the virtual card via the goods and services system may be sent to the mobile computing device. Presenting the virtual card to the card service provider and/or a goods and services system may further include at 434, sending virtual card data and authentication information to the virtual card manager via a suitable communications method (e.g. wired or wireless communication).

In some embodiments, the virtual card engine may interact with the user to confirm the user's intention regarding use of the virtual card (e.g. if a user intends to use the virtual card for a transaction with a goods and services system). Subsequently a user may trigger enablement of the virtual card via an input device or alternatively, enablement may be automated.

The user of the virtual card engine may also select various setting within the virtual card engine, such on or more authentication rules. Thus, a user may customize the virtual care engine according to their liking. However, in other examples selection and/or adjustment of the authentication rules by the virtual card engine may be inhibited. Furthermore, the virtual card engine may also allow a user to bypass selective enablement, in some examples. Thus, a user may choose to set the virtual card in a permanently enabled state to speed up the transaction process if they do not mind taking a risk that could possibly lead to fraudulent card use. However, in other examples, a goods and services system and/or card service provider may inhibit selection of a permanently enabled state to maintain a desired level of security. Communication between the mobile computing device and the virtual card manager may be through the standard ports of communication via the web browser or client based application as this will be the standard method of communication, as described above.

Furthermore in some embodiments a user, card service provider, and/or goods and services system may trigger selective enablement with an MMS or SMS call or other authentication activation step. For example, the user, card service provider, or goods and services system may make a request and then authenticate with their password after a returned request. In some systems, the goods and services system may also be given an override ability through their POS, card service provider, browser-based solution or other software to allow a goods and services system to over-ride a virtual card that does not successfully authenticate. Alternatively, a support telephone number could be called to reach a voice service system or virtual card service representative so that an over-ride can be authorized. The multiple methods can be used as primary or backup solutions. It should be noted that the virtual card manager may log the type of authentication used and if an authentication was not the standard authentication. However, in other examples the virtual card manager may not log the type of authentication used.

When proper authentication is received by the virtual card manager the virtual card in use may be identified in the virtual card manager repository (e.g. manager-side associative card profile). Following which, the virtual card manager may selectively enable the virtual card at 436. Therefore, the virtual card is in an enabled state. Furthermore, periodic authentication may be turned on in response to the selective enablement.

In some embodiments the virtual card may be selectively enabled given one or more of the following: the virtual card engine has been initiated to initiate the process (e.g. transaction), the virtual card identification (e.g. mobile computing device identification) matches the user's authentication, the virtual card engine has passed the levels of authentication required by the card service provider and/or goods and services system, and no other authentication rules have been violated. However, in other embodiment the virtual card may be selectively enabled based on different criteria.

Next at 438, the method may include temporarily enabling the virtual card. Specifically in some embodiments communication may be made with the card service provider to temporarily enable the virtual card. For example, the virtual card manager may communication with the card service provider to turn periodic authentication “on”, thereby “temporarily enabling” the virtual card in the method supported by the card service provider. In this way, the card service provider may be ready for use of the virtual card.

In some examples, if one or more authentication rules were violated or authentication from the virtual card engine (e.g. mobile computing device) was not accepted, the virtual card manager may communicate failure to the virtual card engine and the transaction may be inhibited within the goods and services system. Further in some examples, violation of the authentication rules may result in the virtual card remaining in a temporarily disabled state until the authentication rules are met, thereby inhibiting virtual card use via the goods and services system.

In some example embodiments, a mobile computing device may not be communicatively linked with the virtual card manager when a user desires to make a transaction with a goods and services system thus a virtual card may be selectively enabled when the mobile computing device is communicatively linked to the virtual card manager when a future transaction is anticipated. In some examples, a threshold enablement time interval may be established to allow a user ample time to use the virtual card subsequent to enablement of the virtual card. Thus, the authentication rules may include a time-based rule in which a threshold enablement time interval is established. If the threshold enablement time interval is surpassed the virtual card may be set in a disabled state. The enablement time interval may start when the virtual card is enabled. It will be appreciated that in some embodiments the goods and services system may establish the parameters (e.g. threshold enablement time interval) of the time-based rule. For example, the goods and services system may select a 1 minute or a 20 minute interval. However, in other examples the virtual card manager may set the parameters of the time-based rule.

Again referring to FIG. 4, the method may include at 440, inputting the virtual card data into the goods and services system (e.g. POS system). For example, a virtual card identification number may be manually entered into the POS system and/or a virtual card barcode may be presented on the mobile computing device and scanned into the POS system. It should be appreciated that any suitable method of inputting card identification information may be used to identify the virtual card as presented on the mobile computing device. A CID, security code or multiple security codes of varying lengths and characters may be added to allow for additional security or as part of periodic authentication on behalf of the associated card service provider. Various communication methods may be used, including, but not limited to, Blue Tooth, Remote Identifiers, or other wired and wireless technology which can communicate the virtual card identification from the mobile or electronic device to the goods and services system (e.g. POS software/hardware).

Next at 442 the method may include running the transaction and/or authentication. In some examples, the virtual card engine may initiate the authentication. However, in other examples alternate systems may initiate authentication. As describe above, accessing and viewing the virtual card via the virtual card engine may trigger temporary enablement of the virtual card. Such security initiation may be invisible to the user of the virtual card.

Running a transaction and/or authentication may include at 444 initiating communication between the POS system included in the goods and services system and the card service provider and at 446 sending “successful” authentication to the POS system. Therefore, the POS system may receive the “successful” authentication. In some embodiments, the virtual card manager, using the predetermined authentication rules set by the goods and services system, may communicate with the card service provider just prior to use of the virtual card via a terminal included in the goods and services system to enable use of the virtual card.

In other embodiments, running a transaction and/or authentication may include establishing communication between the goods and services system (e.g. POS system) and the card service provider. Next, the card service provider may initiate a secondary authentication process. Then the card service provider may initiate communication with the virtual card manager. Authentication may then be verified via the virtual card manager. The verification of the authentication (e.g. success or failure) may then be sent to the card service provider and the goods and services system, thereby allowing or disallowing the transaction. However, it will be appreciated that alternate techniques may be used to run a transaction and/or authentication. For example, the card service provider may initiate the enablement and disablement. The initiation to check for a valid virtual card would require the card service provider to make a secondary call or communication to the virtual card manager to validate the authentication after first verifying that their own validation criteria were met. As an example, the card service provider may query the virtual card manager to determine if the virtual card manager has allowed for the authentication per the established authentication rules. It may also be noted that the virtual card manager would not need to “Toggle on or off” the card at the card service provider and/or goods and services system. Rather, the card service provider and/or goods and services system may communicate with the virtual card manager to verify the rules of authentication and then the virtual card manager returns a success or fail indicator.

It will be appreciated that after the transaction is process the virtual cards value may be adjusted via the virtual card manager and/or the card service provider. Adjustment of the value of the virtual card may include a deduction of monetary value or accessing membership privileges.

Next at 448 the method may include notifying the virtual card manager of likely use of the virtual card virtual card. Specifically, in the non-limiting example notifying the virtual card manager of likely use may include alerting the virtual card manager of a likely transaction via the virtual card engine at 450 and at 452 accessing the authentication rules regarding expiration of the virtual card by the virtual card manager. Additionally the virtual card manager may match the virtual card with a corresponding card service provider. Notifying the virtual card manager of likely use may further include at 454 temporarily disabling the virtual card.

In particular, in one example embodiment, cessation of a transaction may occur (e.g. virtual card engine closed via the mobile computing device). The virtual card manager may be notified of cessation by the virtual card engine, mobile computing device, card service provider, etc. For example, the virtual card manager may attempt to look for card use with the card service provider periodically after the virtual card is no longer in use by the virtual card manager. Alternatively, or additionally, the virtual card manager may wait for the authentication window to close. In response to cessation of a transaction the virtual card manager may selectively disable the virtual card and update the manager-side associative card profile. However, other techniques may be used to disabled the virtual card in other examples.

Next at 456 the method may cessation of authentication. Steps 458, 460, and 462 provide an example of cessation of authentication. At 458 the method may include accessing (e.g. retrieving) a new virtual card value. At 460 the method may further include setting the card in a disabled state at the virtual card manager. Next at 462 the method may further include sending card usage details to the mobile computing device. In some embodiments, the virtual card manager may not be notified to temporarily disable the card. In such situations, the virtual card manger may monitor the use of the virtual card via any methods available when the virtual card manager is not notified of card disablement.

Next at 464 the method may further include displaying the virtual card usage data on the mobile computing device. For example, updated value data as well as additional card data that was modified through the transaction may be displayed.

It should be appreciated that a number of the above-described processes may also be used for stored value delivered for use in e-commerce. As such, a user could may access a virtual card form a mobile computing device and then log in to a computer and use that virtual card in the e-commerce world as that virtual card was just authenticated from that device. By allowing the goods and services system to leave a card “disabled” and then “enable” the card just prior to card use for an e-commerce transaction, the virtual card manager can help ensure the proper person is using the virtual card per the rules established by the goods and services system. Further, the virtual card manger may be configured to identify the computer assigned to that virtual card and verify authenticity. Should the user switch computers or need to use the value from another computer the virtual card manage may reissue the stored value to the email address on record with a new pin code, thus re-authenticating the user prior to allowing them to view the virtual card. Viewing the virtual card may effectively enable the card for use in the e-commerce environment.

Furthermore, it should be appreciated that the virtual card manager services and/or the authentication may be managed on the mobile computing device (e.g. thick client approach), in some embodiments. As such, the logic currently held by the virtual card manager may be stored directly on the mobile computing device that allows it to determine which card service provider to communicate or other higher level decision abilities. A thick client approach may for example maintain the cards authentication on the device of which it resides, and be able to implement various virtual card management functions (e.g. selective enablement), based on the virtual card in use. In this manner, the mobile device making decisions that may normally have been made from the external virtual card manager may be transferred to the mobile computing device itself. However, other techniques may be utilized to maintain authentication in other embodiments. Further in other embodiment a thick client approach may not be utilized.

In some example systems, virtual card user data may be stored for use by one or more of the virtual card manager, card service provider or user of the mobile computing device. For example, details regarding use, types of card holders, length of time which a card holder maintains the card, and other information regarding the card holder may be compiled and sorted to provide statistical data and/or card holder information to a merchant and/or other goods and services system.

The systems and methods described above allow a virtual card to be quickly enabled and disabled via an intermediary system (e.g. virtual card manager) based on predetermined authentication rules which may be established via a goods and services system, thereby increasing the security of the virtual card management system. Thus, the goods and services system may build authentication rules around their card program to protect their card holders and prevent loss or fraud. Communication between the card service provider, goods and services system, and the virtual card engine can be taken to another level allowing for new levels of promotional capabilities and interaction with their card holders as a result of this security. This new level of security and authentication can provide a safe transaction experience for all parties involved.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A virtual card management system including one or more servers having memory executable via a processor, comprising:
a virtual card manager executable on the one or more servers including:
an integration connector engine configured to communicatively link at least one card service provider and the virtual card manager; and
a virtual card management platform configured to communicatively link the virtual card manager with at least one virtual card engine, each virtual card engine including one or more virtual cards, the virtual card management platform including:
an enablement module configured to selectively enable a virtual card transaction between at least one virtual card and a corresponding card service provider based on a set of predetermined authentication rules.

2. The virtual card management system of claim 1, wherein the enablement module is further configured to selectively enable at least a second virtual card based on a second set of predetermined authentication rules, the first and second sets of predetermined authentication having different characteristics.

3. The virtual card management system of claim 1, wherein the enablement module is configured to select an enabled or disabled state of a virtual card, an enabled state including a state in which a virtual card transaction between a virtual card and a corresponding card service provider is permitted and a disabled state including a state in which a virtual card transaction between a virtual card and a corresponding card service provider is inhibited.

4. The virtual card management system of claim 3, wherein a virtual card transaction includes at least one of correlation of a virtual card with a corresponding provider-side associative card profile included in a corresponding card service provider and adjustment of one or more characteristics of the virtual card and the provider-side associative card profile in response to implementation of the virtual card transaction.

5. The virtual card management system of claim 3, wherein the virtual card management platform further includes an associative profile module configured to manage a plurality of manager-side associative card profiles corresponding to a plurality of virtual cards implemented via one or more virtual card engines and wherein periodic authentication is implemented while the virtual card is in the enabled state, periodic authentication includes verification of correspondence between identification data of the virtual card and profile identification data in a manager-side associative card profile.

6. The virtual card management system of claim 3, wherein the authentication rules include a configuration rule in which an enabled state is triggered based on a configuration of the virtual card engine, the configuration of the virtual card engine includes a configuration in which the virtual card has been accessed and is open for use.

7. The virtual card management system of claim 3, wherein the authentication rules include a cessation rule in which the virtual card is set in a disabled state in response to cessation of a virtual card transaction.

8. The virtual card management system of claim 3, wherein the card service provider is configured to trigger adjustment of the selectively enabled state of the virtual card within the virtual card manager.

9. The virtual card management system of claim 3, wherein one or more of virtual card engines are configured to trigger adjustment of the selectively enabled state of at least one virtual card within the virtual card manager.

10. The virtual card management system of claim 1, wherein the authentication rules include a card fulfillment rule in which selective enablement is adjusted based on a system utilized to perform an initial configuration of the virtual card, the systems including an Internet-based configuration system, a goods and services system, and a mobile configuration application executed on a mobile computing device.

11. The virtual card management system of claim 1, wherein the authentication rules include a card type rule in which selective enablement is adjusted based on a type of card in use, where types of cards including one or more of a gift card, a membership card, and a rewards card.

12. A method for managing a virtual card, the method comprising:
communicatively linking at least one card service provider and a virtual card manager, each card service provider including at least one provider-side associative card profile;
communicatively linking at least one virtual card engine and the virtual card manager, the virtual card engine including at least one virtual card and the virtual card manager including at least one manager-side associative card profile corresponding to the at least one virtual card; and
periodically authenticating the at least one virtual card by selectively enabling a virtual card transaction between the at least one virtual card and a corresponding card service provider based on a set of predetermined authentication rules.

13. The method of claim 12, further comprising selectively enabling a second virtual card transaction between a second virtual card and a corresponding card service provider based on a second set of predetermined authentication rules, the first and second set of predetermined authentication having different characteristics.

14. The method of claim 12, wherein selectively enabling a virtual card transaction includes setting the at least one virtual card in an enabled state or a disabled state, the disabled state including a state in which a virtual card transaction between the virtual card and the card service provider is inhibited, and the enabled state including a state in which a virtual card transaction is permitted.

15. The method of claim 14, wherein a virtual card transaction includes a value transaction in which a virtual card value within the provider-side associative card profile and the at least one virtual card is adjusted or a privilege transaction in which privileges data within the provider-side associative card profile is accessed and adjusted.

16. The method of claim 14, wherein setting the at least one virtual card in an enabled state triggers periodic authentication of the at least one virtual card, periodic authentication including correlating one or more unique card identifiers included in at least one of the virtual card and a provider-side associative card profile with unique card identifiers included in the manager-side associative card profile.

17. The method of claim 14, further comprising, if the at least one virtual card is in the enabled state and a transaction request has been received by the virtual card manager, permitting the transaction request.

18. The method of claim 12, wherein selectively enabling includes modifying one or more characteristics of the manager-side associative card profile to enable or disable a transaction between at least one virtual card service provider and at least one virtual card, the characteristics including at least one of a virtual card state indicator and a unique card identifier associated with a virtual card.

19. The method of claim 12, further comprising adjusting the authentication rules in response to at least one authentication failure between the virtual card engine and the virtual card manager.

20. The method of claim 12, wherein at least a portion of the virtual card engines are executed on a mobile or stationary computing device and where the at least one virtual card includes at least one of a gift card, a membership card, and a rewards card.

21. A virtual card management system including one or more servers having memory executable via a processor, comprising:
a virtual card manager executable on the one or more servers including:
an integration connector engine configured to communicatively link one or more card service providers and the virtual card manager; and
a virtual card management platform configured to communicatively link the virtual card manager with one or more virtual card engines, each virtual card engine including one or more virtual cards, the virtual card management platform including:
an enablement module configured to periodically enable or disable a virtual card based on a set of predetermined authentication rules such that the virtual card is periodically toggled between an enabled state and a disabled state.

22. The virtual card management system of claim 21, wherein the virtual card management platform further includes an associative profile module configured to manage a manager-side associative card profile corresponding to a virtual card implemented via a virtual card engine and wherein periodic authentication is implemented while the virtual card is in the enabled state, periodic authentication includes verification of correspondence between identification data of the virtual card included in the virtual card and profile identification data included in the corresponding manager-side associative card profile.

23. The virtual card management system of claim 21, wherein the enablement module is further configured to selectively enable at least a second virtual card based on a second set of predetermined authentication rules, the first and second sets of predetermined authentication having different characteristics.
